(19) United States
(12) Patent Application Publication
(10) Pub. No.: US 2010/0145978 A1
(43) Pub. Date: Jun. 10, 2010

(54) TECHNIQUES TO PROVIDE UNIFIED LOGGING SERVICES

(75) Inventors: Oleg N. Anashkin, Redmond, WA (US); Phillip I. Beish, Duvall, WA (US); Shaun P. Eagan, Redmond, WA (US); Thomas K. Forsythe, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/330,076

(22) Filed: Dec. 8, 2008

(51) Int. Cl. G06F 17/30; G06F 7/00

(52) U.S. Cl. 707/769; 707/E17.044

(57) ABSTRACT

Techniques to provide unified logging services are described. An apparatus may comprise a memory to store a diagnostic manager component. A processor may be coupled to the memory, the processor operative to execute instructions for the diagnostic manager component. The diagnostic manager component may be operative to receive diagnostic messages for a diagnostic activity spanning multiple threads within a process, multiple processes or multiple devices, annotate the diagnostic messages with context information to form annotated diagnostic messages, and store the annotated diagnostic messages in a diagnostic log data file. Other embodiments are described and claimed.

### CROSS-REFERENCE TO RELATED APPLICATIONS

The present application is related to U.S. patent application Ser. No. 11/047,317, entitled “On-Line Service/Application Monitoring and Reporting System”, filed on Jan. 31, 2005, assigned to the same assignee as the present application and expressly incorporated herein by reference.

### BACKGROUND

Event generation and logging techniques are important to monitor operational events, report deficiencies, and facilitate debugging operations for software applications. This may be particularly important for on-line services. On-line services or applications are hosted at a server-side central data center which is communicatively linked to remote client-side terminals. Principal goals of this on-line service include presenting, sorting and distributing documents universally across a network of client terminals and servers with 24 hour, 7 day/week accessibility. The different design considerations, security levels and technologies that may be used to create an “integrated” on-line service, however, serve to create discrepancies in the quality and depth of instrumentation capabilities within and between interrelated software code. Developers may be confused as to what instrumentation technologies to use and may, therefore, instrument their software code in an inconsistent manner or, in some cases, not at all. Ultimately, the gaps in monitoring, maintenance and debugging capabilities make providing a consistently reliable on-line service difficult to implement. There is a need, therefore, in the industry for a system, including apparatuses and methods, for instrumenting on-line service software code to generate events, for monitoring generated events, for alerting appropriate personnel upon the occurrence of certain generated events, and for logging generated events for subsequent use in troubleshooting and debugging on-line service software code. It is with respect to these and other considerations that the present improvements have been needed.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

Various embodiments are generally directed to techniques to provide unified logging services to assist in troubleshooting and debugging hardware and software services. Some embodiments are particularly directed to techniques to pass context information between multiple threads in a process, multiple processes, or multiple devices through diagnostic messages generated and stored by unified logging services.

In one embodiment, for example, an apparatus may comprise a computing device, such as a general purpose computer or special purpose computer, having a processing system. The processing system may include a memory to store a diagnostic manager component, and a processor coupled to the memory. The processor may be operative to retrieve and execute instructions for the diagnostic manager component. The diagnostic manager component may be operative to receive diagnostic messages for a diagnostic activity spanning multiple threads within a process, multiple processes or multiple devices, annotate the diagnostic messages with context information to form annotated diagnostic messages, and store the annotated diagnostic messages in a diagnostic log data file. A diagnostic reporting component may then selectively filter and retrieve the annotated diagnostic messages using the context information, organize the retrieved diagnostic messages in different report views using a graphic user interface (GUI), and display the report views to an operator, such as a developer or customer service technician. The operator may then have a more comprehensive and holistic view of problems indicated by the displayed diagnostic messages, thereby recognizing and resolving potential problems across an entire diagnostic activity rather than for isolated events. Other embodiments are described and claimed.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

FIG. 1 illustrates an embodiment of a first system.

FIG. 2 illustrates an embodiment of a second system.

FIG. 3 illustrates an embodiment of a distributed system.

FIG. 4 illustrates an embodiment of a centralized system.

FIG. 5A illustrates an embodiment of a first diagnostic log.

FIG. 5B illustrates an embodiment of a second diagnostic log.

FIG. 6 illustrates an embodiment of a logic flow.

FIG. 7 illustrates an embodiment of a computing architecture.

FIG. 8 illustrates an embodiment of a communications architecture.

### DETAILED DESCRIPTION

Debugging errors in large distributed server and service applications is very difficult. Servicing an individual diagnostic activity (e.g., a user request) often requires running code that spans multiple threads within a process, multiple processes, multiple machines, or even multiple networks. Debugging errors in these types of applications has been previously difficult because there is no standard way to pass context between these layers and to obtain an overall view of all hardware and software activities that were utilized to service a diagnostic activity, such as a user request.

Various embodiments attempt to improve the debugging experience by providing techniques to pass context information between threads, processes, machines and networks, and providing a view of all code execution regardless of these boundaries. This potentially improves debugging operations by allowing a developer to associate extra metadata with a user activity and later view that metadata along with all messages related to the activity. Additionally or alternatively, some embodiments include the ability to visualize a hierarchy of activities that make up a diagnostic activity (e.g., user request) or other large operation.

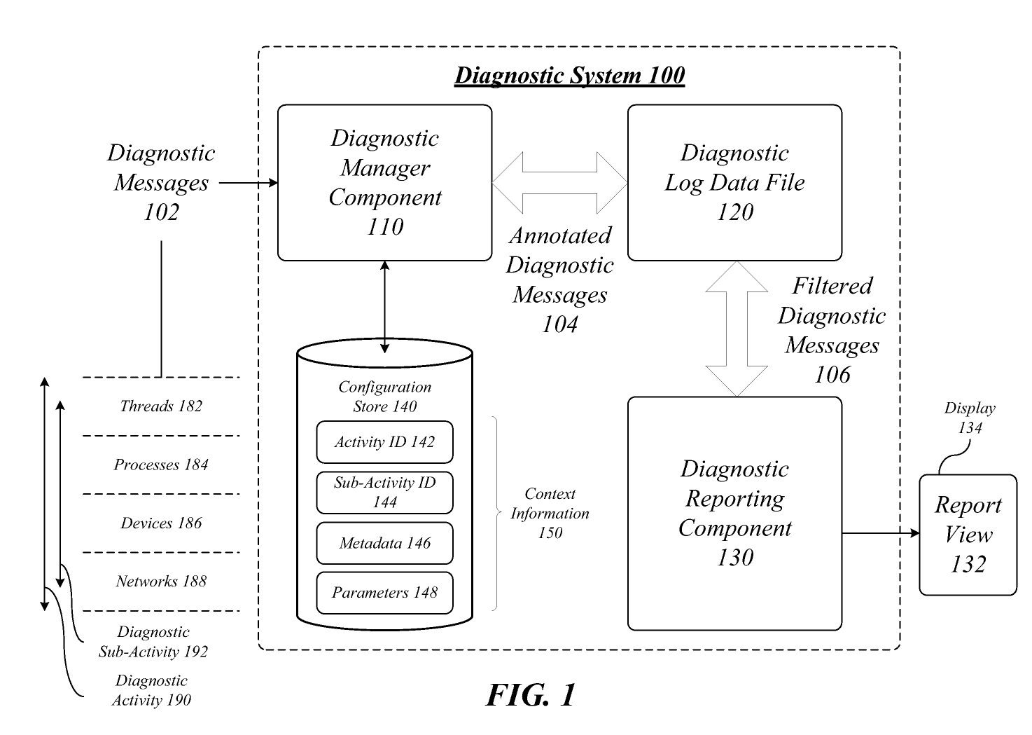

FIG. 1 illustrates a block diagram for a diagnostic system 100 that enables the monitoring and logging of diagnostic activities and events that may occur relative to off-line or on-line computer services, particularly software application programs. Such computer software application programs include without limitation word processing programs, spreadsheet programs, presentation programs, security programs, and other computer software application and related programs which have been previously instrumented by their developers to generate certain diagnostic messages of different types and associated information, upon the occurrence of certain corresponding conditions encountered during their execution.

In one embodiment, for example, the diagnostic system 100 may comprise a computer-implemented diagnostic system 100 having multiple components 110, 120, 130 and 140. As used herein the terms “system” and “component” are intended to refer to a computer-related entity, comprising either hardware, a combination of hardware and software, software, or software in execution. For example, a component can be implemented as a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers as desired for a given implementation. The embodiments are not limited in this context.

In the illustrated embodiment shown in FIG. 1, the diagnostic system 100 may be implemented as part of an electronic device. Examples of an electronic device may include without limitation a mobile device, a personal digital assistant, a mobile computing device, a smart phone, a cellular telephone, a handset, a one-way pager, a two-way pager, a messaging device, a computer, a personal computer (PC), a desktop computer, a laptop computer, a notebook computer, a handheld computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combination thereof. Although the diagnostic system 100 as shown in FIG. 1 has a limited number of elements in a certain topology, it may be appreciated that the diagnostic system 100 may include more or less elements in alternate topologies as desired for a given implementation.

The components 110, 120, 130 and 140 may be communicatively coupled via various types of communications media. The components 110, 120, 130 and 140 may coordinate operations between each other. The coordination may involve the uni-directional or bi-directional exchange of information. For instance, the components 110, 120, 130 and 140 may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The components 110, 120, 130 and 140 include, generally, a plurality of computer software programs or routines and a plurality of data elements which, when executed and/or utilized by a respective computing device, direct and cause the computing device to: generate events upon the occurrence or existence of particular conditions during the execution of a service or related computer program; configure and start concurrent event tracing sessions (e.g., a real-time tracing session and a near-real-time tracing session) for the service; monitor a stream of generated diagnostic activities and diagnostic messages from the service in real-time according to one or more thresholds (including, logical expressions and threshold values) and configuration parameters; produce and send alerts to a data center system (with appropriate troubleshooting or debugging personnel) when the thresholds are exceeded by generated diagnostic activities identified for real-time monitoring in accordance with such configuration parameters; and store such generated events and data related thereto in a diagnostic log data file.

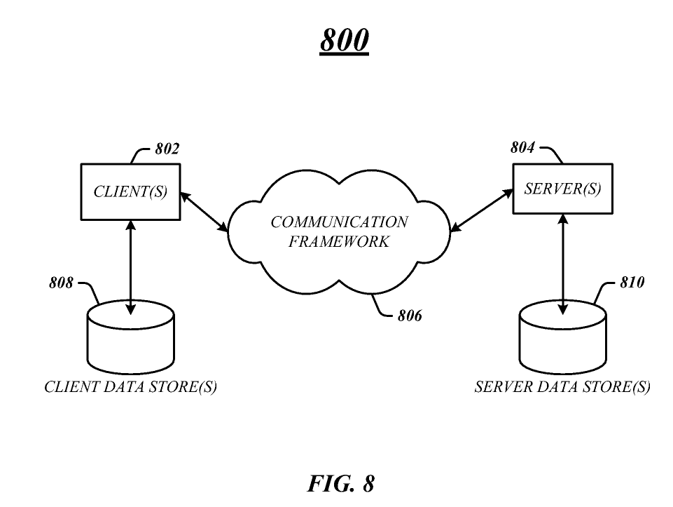

In one embodiment, for example, an apparatus may comprise a computing device, such as a general purpose computer or special purpose computer, having a processing system. The processing system may include a memory to store some or all of the diagnostic system 100, including a diagnostic manager component 110, a diagnostic log data file 120, a diagnostic reporting component 130, and a configuration store 140. A processor may be coupled to the memory. The processor may be operative to retrieve and execute instructions for the diagnostic manager component 110 and/or the diagnostic reporting component 130. A more detailed block diagram of a computing device suitable to implement one or more elements of the diagnostic system 100 may be illustrated and described with reference to FIG. 8.

In various embodiments, the diagnostic system 100 may be implemented as one or more software components which reside and are stored on various devices providing diagnostic services. Some or all of the software components may comprise various application program interfaces (APIs) arranged to provide diagnostic monitoring, logging, filtering, and reporting operations. The APIs may comprise multiple computer software procedures or routines that may be identified by a software developer and embedded in the source code of software, such as an application program.

The diagnostic manager component 110 may be operative to receive diagnostic messages 102 for a diagnostic activity 190 spanning multiple transaction boundaries or layers, such as one or more processing threads 182, multiple processes 184, multiple devices 186, or multiple networks 188. The diagnostic manager component 110 may annotate the diagnostic messages 102 with context information 150 to form annotated diagnostic messages 104, and store the annotated diagnostic messages 104 in a diagnostic log data file 120. A diagnostic reporting component 130 may then selectively filter and retrieve certain annotated diagnostic messages 104 using the context information 150, organize the retrieved diagnostic messages 104 in different report views 132, and display the report views 132 to an operator via a display 134. The operator may then have a more comprehensive view of problems indicated by the displayed diagnostic messages 104, thereby recognizing and resolving potential problems across the entire diagnostic activity 190.

The diagnostic manager component 110 may be operative to receive diagnostic messages 102 for the diagnostic activity 190 spanning multiple threads 182 (e.g., within a single or multiple processes), multiple processes 184, multiple devices 186 or multiple networks 188. The diagnostic activity 190 may comprise any request, transaction, event, or other unit of work suitable for monitoring and debugging operations. In some cases, the diagnostic activity 190 may span multiple transaction boundaries. For instance, during processing of a web request, a device such as a server may need to perform security operations using authentication protocols and information from a different server, perform protocol translations between different networks, interact with a database utilizing various types of database languages, call out a web service, read configuration values, and so forth. Conventional logging systems typically treat each transaction boundary as a separate domain, with each domain utilizing a different set of instruments, diagnostic techniques, and reporting tools. As such, it may be difficult to coordinate diagnostic operations across these multiple transaction boundaries. The diagnostic manager component 110 is designed to operate across multiple transaction boundaries, however, thereby allowing an operator (e.g., developer, customer service operator, etc.) to more quickly identify global problems and solutions.

The diagnostic activity 190 may correspond to a particular type of activity and may be identified in the source code of a service or application program by a software developer to, typically, cause the generation of an activity (and associated activity data) having a type which is appropriate for an associated condition occurring during the service's execution or for the logging of information helpful to diagnose problems with the service. The types of activities include, but are not limited to: (i) a critical activity; (ii) a general diagnostic, or trace, activity; (iii) a transaction activity; (iv) a ship assert activity; (v) an assert activity; (vi) an exception activity; and, (vii) a performance counter activity. A critical activity is identified by a software developer for generation during a service's execution when the service encounters an error state, or condition, serious enough that someone should be paged or otherwise contacted to address the service's condition. A general diagnostic, or trace, activity is identified and embedded in the source code when a software developer desires to log diagnostic data representing the state, or condition, of the service at the time and location in the source code that the activity is encountered during execution of the service. A transaction activity is identified for generation by a software developer in the source code of a service to track the duration of a multi-stage process of the service when more than one instance of the process may be contemporaneously executing on different devices, and allows multiple activities to be properly identified as “children” of a single transaction. Ship assert activities and assert activities are identified and embedded in the source code of a service when a software developer desires to cause the generation of a logged activity and, optionally, a dump in production and debug grades of code. An exception activity is embedded by a software developer in a service's source code when the developer desires to determine when unhandled exceptions occur during the service's execution. A performance counter activity is identified by a software developer for generation during a service's execution to log the value of a specified variable. It may be appreciated that these are merely a few examples of various types for the diagnostic activity 190, and any defined set of hardware and/or software operations may be considered a diagnostic activity 190 that is monitored, logged and reported by the diagnostic system 100.

The diagnostic manager component 110 may be operative to annotate the diagnostic messages 102 with certain context information 150 to form annotated diagnostic messages 104. The context information 150 may comprise any information that uniquely identifies the diagnostic messages 102 as part of a given diagnostic activity 190. For instance, the context information 150 may include an activity identifier (ID) 142 that comprises a globally unique identifier (GUID) or other unique identifier for a diagnostic activity 190 that is created when a start API is called for the diagnostic activity. Furthermore, the context information 150 may include a diagnostic sub-activity ID that comprises a GUID for a diagnostic sub-activity 192 of a diagnostic activity 190. In addition, the context information 150 may comprise metadata 146 that describes the diagnostic activity or a portion of the diagnostic activity. For instance, the metadata 146 may comprise various words and phrases of varying levels of detail (verbosity), or metadata values that control a particular level of detail given to diagnostic messages 102 for some duration of a diagnostic activity 190 or sub-activity 192. The metadata 146 may also contain information descriptive of a diagnostic activity 190 or sub-activity 192, such as a document name, user name, session identifier, version number, synchronization data, and so forth. Additionally or alternatively, a transfer of control message can be written to the diagnostic log data file 120 to indicate relationships between activities and sub-activities. Although some embodiments have the diagnostic manager component 110 inserting additional information directly into the diagnostic messages 102, it may be appreciated that the diagnostic manager component 110 may, additionally or alternatively, insert additional information directly into the diagnostic log data file 120.

In one embodiment, for example, the metadata 146 associated with the activity ID 142 may comprise a set of key-value pairs. The key may represent a name and type of data to be stored in the diagnostic log data file 120. For instance, the key may comprise a name for the data, and the actual data may be converted to a string and stored in the diagnostic log data file 120 as a string datatype. The value may represent a metadata value. For instance, from within the context of a diagnostic activity 190, a client can call an Add API to associate metadata with the lifetime of the diagnostic activity 190. This metadata is composed of (Key, Value) pairs. The Key represents the name and type of data to be stored, while the Value contains the actual metadata value. This information is stored in the diagnostic log data file 120 along with the activity ID 142 and/or sub-activity ID 144. Later, during processing or analysis of the diagnostic log data file 120, the log viewing and reporting tools can extract the metadata 146 out of the diagnostic log data file 120, and promote it in a conspicuous fashion to allow better analysis. For instance, the log viewing and reporting tool could provide special highlighting or filtering options for the metadata 146, or instantiate additional columns of metadata 146 with every diagnostic message 102, 104, thus providing additional context information to the viewer.

In one embodiment, for example, the diagnostic manager component 110 may be operative to receive diagnostic messages 102 for the diagnostic activity 190, where the diagnostic messages 102 represent a diagnostic sub-activity 192 nested within the diagnostic activity 190. A diagnostic sub-activity 192 may comprise a set of operations performed in response to, or because of, the diagnostic activity 190. For instance, during processing of a web request, a device such as a server may need to perform security operations, interact with a database, call out a web service, read configuration values, and so forth. These operations may represent a sub-set of causally linked activities initiated by, and within the larger scope of, the diagnostic activity 190.

The diagnostic manager component 110 may receive a diagnostic message 102, and retrieve context information from the configuration store 140. For example, the diagnostic manager component 110 may retrieve an activity identifier (ID) 142 for a diagnostic activity, a sub-activity ID 144 when the diagnostic message 102 is for a sub-activity of the diagnostic activity, or metadata 146. The diagnostic manager component 110 may then annotate or add the retrieved context information 150 to the diagnostic message 102 to form the corresponding annotated diagnostic message 104. The difference between a diagnostic message 102 and an annotated diagnostic message 104, if any, may in part be measured by the amount of additional information inserted into the diagnostic message 102, such as an activity ID 142, a sub-activity ID 144, metadata 146, and so forth.

The diagnostic manager component 110 may control a level of description for the diagnostic messages 102 based on the associated metadata 146. Because the metadata 146 directly describes the diagnostic activity 190 as they occur, the diagnostic manager component 110 may implement features to define custom filtering criteria based on the metadata 146. For instance, the diagnostic log data file 120 can be configured to persist a subset of trace statements (e.g., only error statements), and discard more common trace statements (e.g., such as verbose data flow descriptions). In this case, an optional filter component may be inserted between the diagnostic manager component 110 and the diagnostic log data file 120, to filter out any undesired information from the diagnostic messages 102 that should not be persisted to the diagnostic log data file 120. The diagnostic manager component 110 can take advantage of the metadata 146 associated with the diagnostic activity 190 to selectively enable or disable verbose diagnostic detail based on the values persisted in the metadata 146. In one implementation, the administrator can define the (Key, Value) pairs in the persistent configuration store 140. When the software code executes a call to an Add API, it can consult the configuration store 140, and if indicated by the metadata 146 associated with the activity ID of the diagnostic activity 190, enable more verbose annotated diagnostic messages 104 for the remainder of the diagnostic activity 190.

The diagnostic manager component 110 may be operative to store the diagnostic messages 102 and/or the annotated diagnostic messages 104 in the diagnostic log data file 120. The diagnostic log data file 120 is designed to be a unified logging repository that stores diagnostic information for a diagnostic activity 190, such as diagnostic messages 102 and/or annotated diagnostic messages 104.

The diagnostic reporting component 130 may be generally arranged to generate various reports with the diagnostic messages 102 and/or annotated diagnostic messages 104 stored by the diagnostic log data file 120. In one embodiment, for example, the diagnostic reporting component 130 may be operative to generate a report view 132 of the diagnostic messages 102 and/or annotated diagnostic messages 104 stored in the diagnostic log data file 120 based on the context information 150 for presentation on a display 134. The diagnostic reporting component 130 may generate the report view 132 with messages 102, 104 visualized in a conspicuous manner to facilitate analysis by an operator (e.g., developer, customer service operator, etc.). For instance, the report view 132 could provide special highlighting for the metadata 146 associated with the messages 102, 104, instantiate additional columns of data for each of the messages 102, 104, or implement other visual techniques to provide a context for the operator.

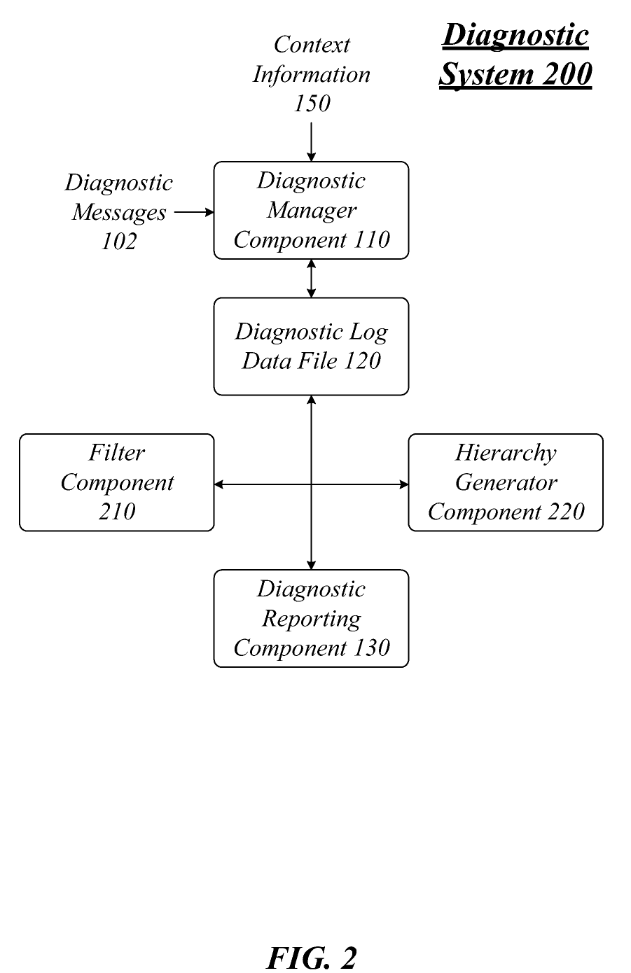

FIG. 2 illustrates a block diagram of a system 200 that enables the monitoring and logging of diagnostic activities and events that may occur relative to off-line or on-line computer software application programs. The system 200 may be similar to the diagnostic system 100, and may further comprise a filter component 210 and a hierarchy generator component 220.

The filter component 210 is generally arranged to perform filter operations for the diagnostic messages 102, 104 stored by the diagnostic log data file 120. In one embodiment, the filter component 210 may be operative to filter a set of diagnostic messages 102, 104 stored in the diagnostic log data file 120 based on the context information 150 to form a set of filtered diagnostic messages 106. For instance, the filter component 210 may filter a set of diagnostic messages 102, 104 based on an activity ID 142, a sub-activity ID 144, or the metadata 146, among other types of context information 150.

The hierarchy generator component 220 is generally arranged to generate hierarchical data for the diagnostic messages 102, 104 stored by the diagnostic log data file 120. In one embodiment, for example, the hierarchy generator component 220 may be operative to take the relatively “flat” information stored in the diagnostic log data file 120, and generate a hierarchical structure for the diagnostic messages 102, 104 based on the context information 150. A hierarchical structure may comprise any structure providing a parent-child relationship between a diagnostic activity 190 and a diagnostic sub-activity 192 for the diagnostic activity 190. When presented as a report view 132, for example, the hierarchical structure may be visually represented by a tree structure, with nodes and connectors (or edges).

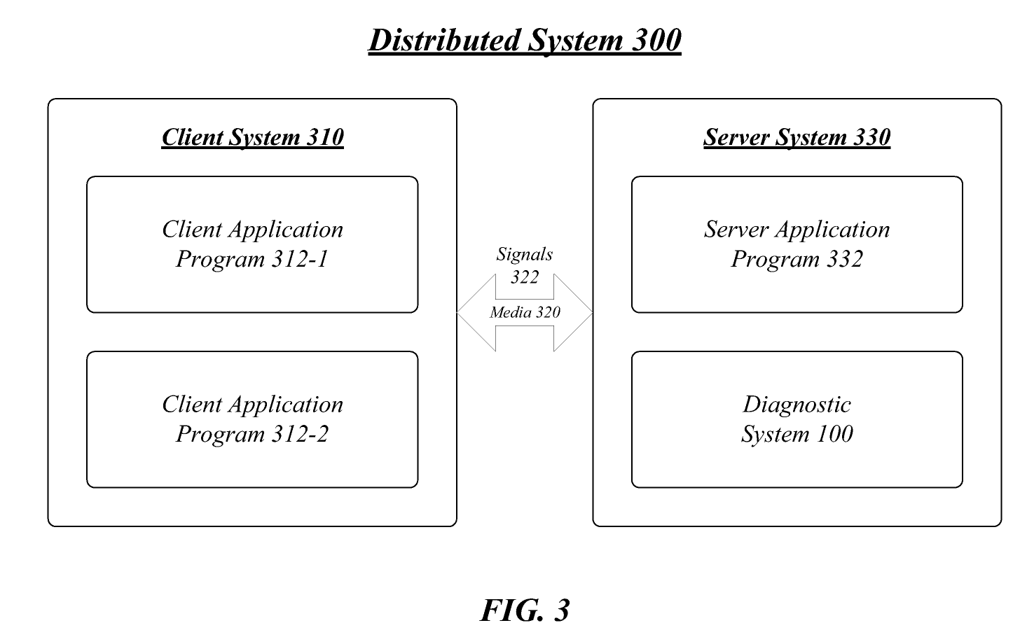

FIG. 3 illustrates a block diagram of a distributed system 300. The distributed system 300 may distribute portions of the structure and/or operations for the systems 100, 200 across multiple computing entities. Examples of distributed system 300 may include without limitation a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

In one embodiment, for example, the distributed system 300 may be implemented as a client-server system. A client system 310 may implement one or more client application programs 312-1-m. A server system 330 may implement a server application program 332, and one or more of the diagnostic systems 100, 200. Exemplary computer operating systems for each system 310, 330 include Microsoft® Windows® NT Back Office Server, Microsoft® Windows® XP, or Microsoft® Vista®. Exemplary communications software for each system 310,330 includes Microsoft® Internet Explorer®, Microsoft® Office, or Microsoft® Communicator It may be appreciated that this configuration may be reversed, with the client system 310 implementing one or both of the diagnostic systems 100, 200. The embodiments are not limited in this context.

The client system 310 and the server system 330 may communicate with each over a communications media 320 using communications signals 322. In one embodiment, for example, the communications media may comprise wired or wireless communications media. In one embodiment, for example, the communications signals 322 may comprise data signals or messages, including calls to one or more diagnostic APIs provided by the diagnostic systems 100, 200, events, Start APIs and End APIs for a diagnostic activity 190, diagnostic messages 102, requests for report views 132, and other diagnostic related communications.

By way of example, assume client application programs 312-1, 312-2 are executing various diagnostic sub-activities 192 of a diagnostic activity 190. For example, assume the client application program 312-1 is a web browser, and the client application 312-2 is a local instantiation of an online service provided by the server application program 332. For instance, Microsoft® Office 2007 provides several “suite” services that have been traditionally offered as fixed media software through an Internet-accessible web site. On-line services or applications are hosted at a server-side central data center (e.g., server system 330) which is communicatively linked to remote client-side terminals (e.g., client system 310). During development, run-time or near run-time of the client application programs 312-1, 312-2, the client application programs 312-1, 312-2 may generate a diagnostic activity 190.

Further assume the client system 310 calls a Start API and an End API to indicate a respective start point and end point for a diagnostic activity 190. Further, the client system 310 may call the Start API and End API from a nested sub-activity 192 of the diagnostic activity 190. Although called by the client system 310, the diagnostic data is typically generated by the server system 330. The diagnostic data, however, may also be generated by the client system 310 for some implementations.

As an example, during the processing a web request from the client application program 312-1, the server application program 332 may download a local instantiation of an online service, such as a word processing program as the client application program 312-2, and begin providing word processing services via the interoperability and interactions between application programs 312-2, 332. Meanwhile, the diagnostic system 100 may begin monitoring and logging diagnostic messages 102, 104 to the diagnostic log data file 120. Each of these could appear as nested activities within the larger “process request” activity of the diagnostic activity 190. When the client system 310 calls the Start API, a globally unique identifier (GUID) is created as an activity ID 142 for the diagnostic activity 190. The diagnostic manager component 110 stores the activity ID 142 at the top of an internal stack. Every diagnostic activity 190 has a separate stack to store the activity ID 142. Each time the client system 310 writes diagnostic or trace data, the activity ID 142 is retrieved from its stack and included in the diagnostic output. Optionally, the API will write a diagnostic message indicating the start of the activity. When the client system 310 calls the End API, the topmost activity ID 142 is removed from the stack. Optionally, the API will write a diagnostic message indicating the end of the activity. If the call represents the end of a nested activity, subsequent trace messages would therefore contain the activity ID 142 of the outer parent diagnostic activity 190. In this way, the diagnostic system 100 can gather metadata 146 about the diagnostic activity 190. This allows identification of how different diagnostic activities are related, and view the execution flow from one diagnostic activity to another diagnostic activity.

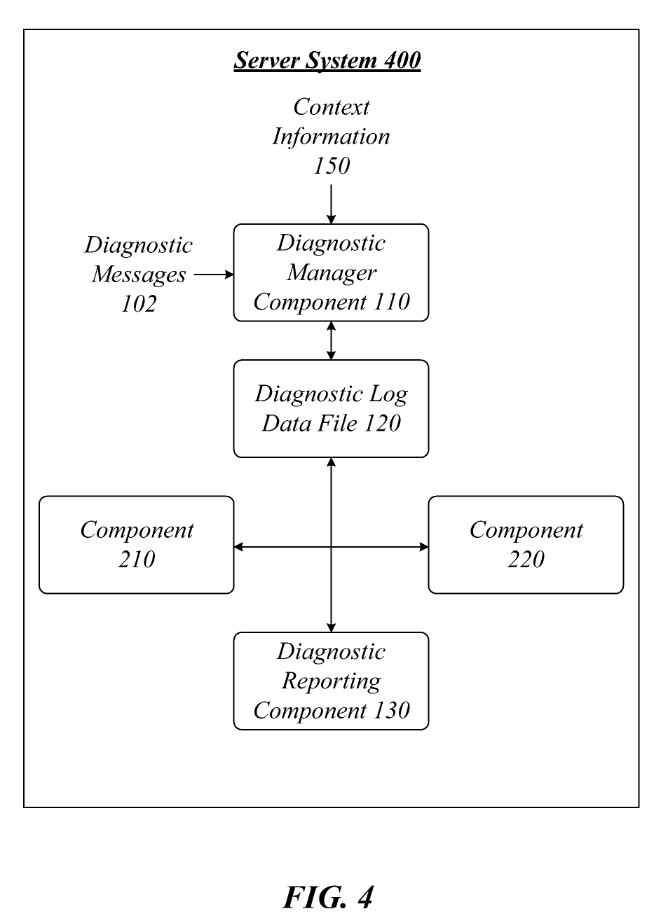

FIG. 4 illustrates a block diagram of a centralized system 400. The centralized system 400 may implement all of the structure and/or operations for the systems 100, 200 in a single computing entity. In one embodiment, for example, the centralized system 400 may implement the structure and/or operations for the systems 100, 200 entirely within a single computing device, such as a server system 400. The server system 400 may be implemented as part of an error reporting server computer accessible via a public network such as the Internet, a corporate error reporting file server computer accessible via a private network such as an intranet, and so forth.

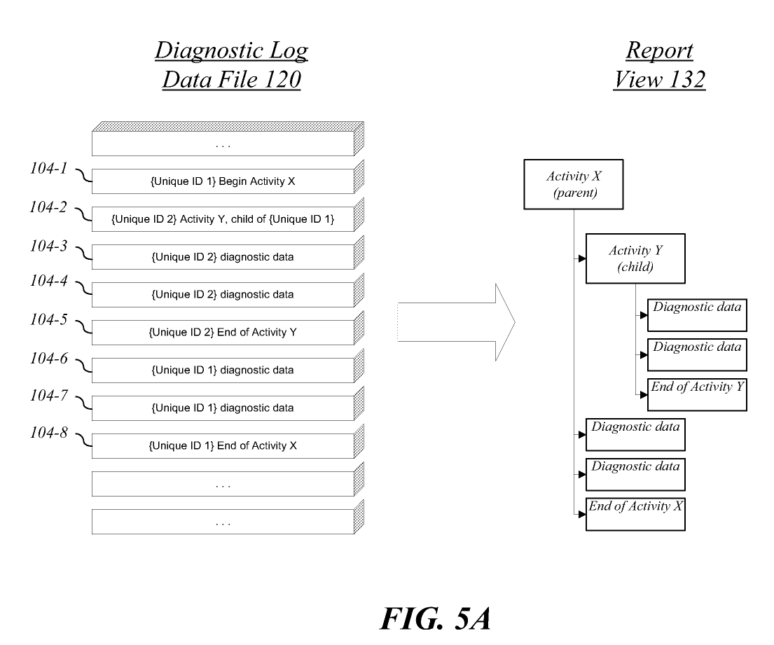

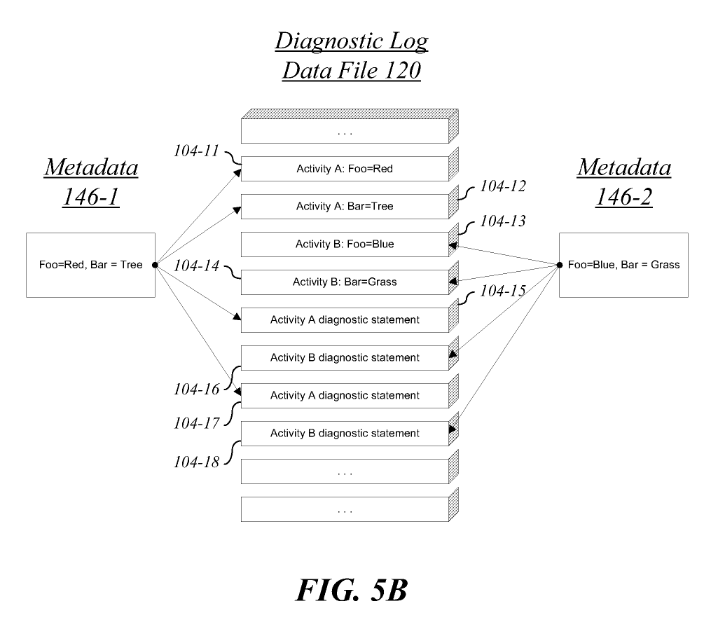

FIG. 5A illustrates an embodiment of a diagnostic log data file 120 that is used by the hierarchy generator component 220 and the diagnostic reporting component 130 to generate a report view 132. The report view 132 shown in FIG. 5A comprises a hierarchical report view of a diagnostic activity 190. More particularly, the report view 132 illustrates the diagnostic log data file 120 having multiple annotated diagnostic messages 104-1-n. For instance, the diagnostic log data file 120 may include annotated diagnostic messages 104-2, having diagnostic information for a diagnostic activity X and a diagnostic sub-activity Y nested within the diagnostic activity X. The diagnostic activity X may have a first set of annotated diagnostic messages 104-1, 104-6, 104-7 and 104-8. The first set of annotated diagnostic messages may each include an activity ID 142, such as a GUID illustrated as {Unique ID 1 }. The diagnostic sub-activity Y may have a second set of annotated diagnostic messages 104-2, 104-3, 104-4 and 104-5. The second set of annotated diagnostic messages may each include a sub-activity ID 144, such as a GUID illustrates as {Unique ID 2}. The first annotated diagnostic message 104-2 of the second set of annotated diagnostic messages may include not only the sub-activity ID 144 for the diagnostic sub-activity Y, but also the activity ID 142 for the diagnostic activity X. In this manner, the diagnostic sub-activity Y is designated as a child sub-diagnostic activity Y of the parent diagnostic activity X, thereby the diagnostic systems 100, 200 are capable of inferring a hierarchical structure from the flat-list of annotated diagnostic messages 104-1-n persisted in the diagnostic log data file 120.

Continuing with this example, the filter component 210 may filter the first and second sets of annotated diagnostic messages 104-1-n from all of the diagnostic messages 102, 104 written to the diagnostic log data file 120 to form filtered diagnostic messages 106. The filtered diagnostic messages 106 are then passed to the hierarchy generator component 220. The hierarchy generator component 220 may receive the filtered diagnostic messages 106, and use the activity ID 142 and sub-activity ID 144 to generate the report view 132 with a hierarchical structure for the filtered diagnostic messages 106. The diagnostic reporting component 130 may then generate a report view 132 with a tree view of the hierarchical structure.

FIG. 5B illustrates an embodiment of the diagnostic log data file 120 that stored annotated diagnostic messages 104-11 through 104-18. The annotated diagnostic messages 104-11, 104-12, 104-15 and 104-17 for diagnostic activity A may be associated with a set of metadata 146-1, illustrated in FIG. 5B as “Foo=Red, Bar=Tree.” The annotated diagnostic messages 104-13, 104-14, 104-16 and 104-18 for diagnostic activity B may be associated with a set of metadata 146-2, illustrated as “Foo=Blue, Bar=Grass.” In the illustrated embodiment shown in FIG. 5B, the diagnostic activities A, B and corresponding metadata 146-1, 146-2 are written into the beginning of the diagnostic log data file 120. Subsequent annotated diagnostic messages for each of the diagnostic activities A, B may then be associated with the corresponding metadata 146-1, 146-2 by the diagnostic reporting component 130.

Operations for the above-described embodiments may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more hardware elements and/or software elements of the described embodiments or alternative elements as desired for a given set of design and performance constraints. For example, the logic flows may be implemented as logic (e.g., computer program instructions) for execution by a logic device (e.g., a general-purpose or specific-purpose computer).

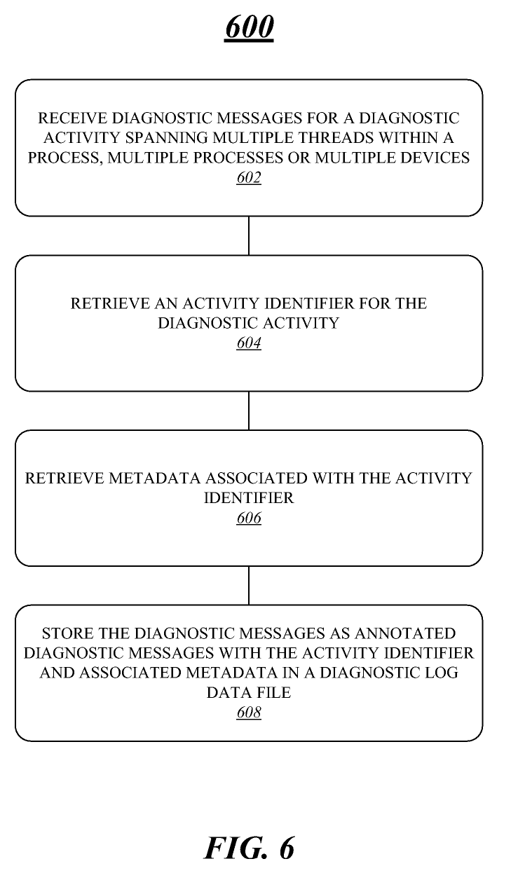

FIG. 6 illustrates one embodiment of a logic flow 600. The logic flow 600 may be representative of some or all of the operations executed by one or more embodiments described herein.

In the illustrated embodiment shown in FIG. 6, the logic flow 600 may receive diagnostic messages for a diagnostic activity spanning multiple threads within a process, multiple processes or multiple devices at block 602. For example, the diagnostic manager component 110 of the diagnostic systems 100, 200 may receive diagnostic messages 102 for a diagnostic activity 190 spanning multiple threads 182 within a process, multiple processes 184 or multiple devices 186. The embodiments are not limited in this context.

The logic flow 600 may retrieve an activity identifier for the diagnostic activity at block 604. For example, the diagnostic manager component 110 of the diagnostic systems 100, 200 may retrieve an activity ID 142 for the diagnostic activity 190. The embodiments are not limited in this context.

The logic flow 600 may retrieve metadata associated with the activity identifier at block 606. For example, the diagnostic manager component 110 of the diagnostic systems 100, 200 may retrieve metadata 146 associated with the activity ID 142. Additionally or alternatively, the diagnostic manager component 110 may store the received diagnostic messages 102 in the diagnostic log data file 120 without the metadata 146, and add the metadata 146 to the stored diagnostic messages 102 when the diagnostic log data file 120 is processed and displayed to an operator on demand. The embodiments are not limited in this context.

The logic flow 600 may store the diagnostic messages as annotated diagnostic messages with the activity identifier and associated metadata in a diagnostic log data file at block 608. For example, the diagnostic manager component 110 of the diagnostic systems 100, 200 may store the annotated diagnostic messages 104-1-n with the activity ID 142 and associated metadata 146 in the diagnostic log data file 120. The embodiments are not limited in this context.

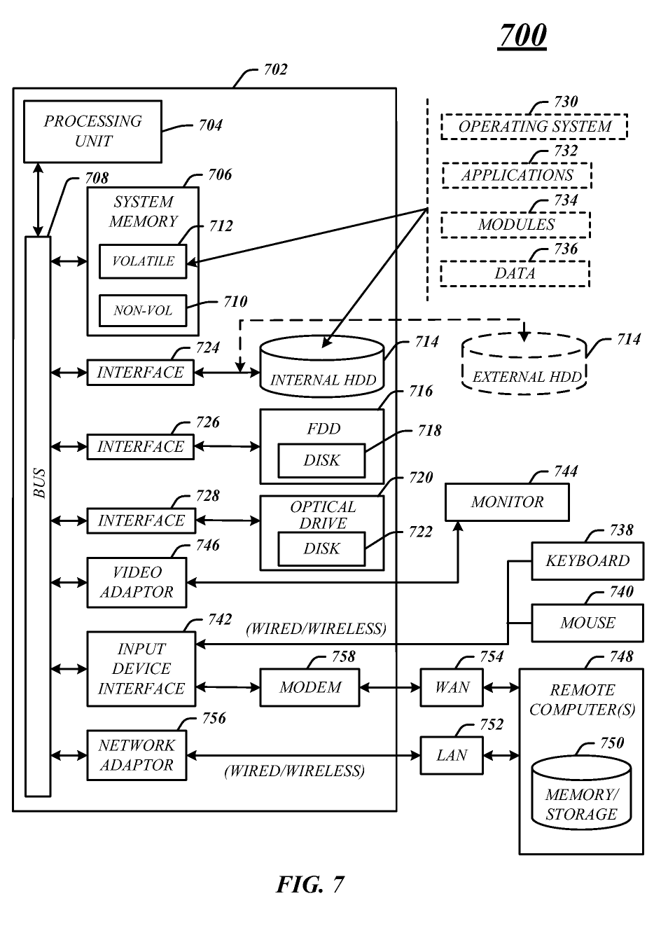

FIG. 7 illustrates an embodiment of an exemplary computing architecture 700 suitable for implementing various embodiments as previously described. The computing architecture 700 includes various common computing elements, such as one or more processors, co-processors, memory units, chipsets, controllers, peripherals, interfaces, oscillators, timing devices, video cards, audio cards, multimedia input/output (I/O) components, and so forth. The embodiments, however, are not limited to implementation by the computing architecture 700.

As shown in FIG. 7, the computing architecture 700 comprises a processing unit 704, a system memory 706 and a system bus 708. The processing unit 704 can be any of various commercially available processors. Dual microprocessors and other multi-processor architectures may also be employed as the processing unit 704. The system bus 708 provides an interface for system components including, but not limited to, the system memory 706 to the processing unit 704. The system bus 708 can be any of several types of bus structure that may further interconnect to a memory bus (with or without a memory controller), a peripheral bus, and a local bus using any of a variety of commercially available bus architectures.

The system memory 706 may include various types of memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. In the illustrated embodiment shown in FIG. 7, the system memory 706 can include non-volatile memory 710 and/or volatile memory 712. A basic input/output system (BIOS) can be stored in the non-volatile memory 710.

The computer 702 may include various types of computer-readable storage media, including an internal hard disk drive (HDD) 714, a magnetic floppy disk drive (FDD) 716 to read from or write to a removable magnetic disk 718, and an optical disk drive 720 to read from or write to a removable optical disk 722 (e.g., a CD-ROM or DVD). The HDD 714, FDD 716 and optical disk drive 720 can be connected to the system bus 708 by a HDD interface 724, an FDD interface 726 and an optical drive interface 728, respectively. The HDD interface 724 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 710, 712, including an operating system 730, one or more application programs 732, other program modules 734, and program data 736. The one or more application programs 732, other program modules 734, and program data 736 can include, for example, the diagnostic systems 100, 200.

A user can enter commands and information into the computer 702 through one or more wire/wireless input devices, for example, a keyboard 738 and a pointing device, such as a mouse 740. Other input devices may include a microphone, an infra-red (IR) remote control, a joystick, a game pad, a stylus pen, touch screen, or the like. These and other input devices are often connected to the processing unit 704 through an input device interface 742 that is coupled to the system bus 708, but can be connected by other interfaces such as a parallel port, IEEE 1394 serial port, a game port, a USB port, an IR interface, and so forth.

A monitor 744 or other type of display device is also connected to the system bus 708 via an interface, such as a video adaptor 746. In addition to the monitor 744, a computer typically includes other peripheral output devices, such as speakers, printers, and so forth.

The computer 702 may operate in a networked environment using logical connections via wire and/or wireless communications to one or more remote computers, such as a remote computer 748. The remote computer 748 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 750 is illustrated. The logical connections depicted include wire/wireless connectivity to a local area network (LAN) 752 and/or larger networks, for example, a wide area network (WAN) 754. Such LAN and WAN networking environments are commonplace in offices and companies, and facilitate enterprise-wide computer networks, such as intranets, all of which may connect to a global communications network, for example, the Internet.

When used in a LAN networking environment, the computer 702 is connected to the LAN 752 through a wire and/or wireless communication network interface or adaptor 756. The adaptor 756 can facilitate wire and/or wireless communications to the LAN 752, which may also include a wireless access point disposed thereon for communicating with the wireless functionality of the adaptor 756.

When used in a WAN networking environment, the computer 702 can include a modem 758, or is connected to a communications server on the WAN 754, or has other means for establishing communications over the WAN 754, such as by way of the Internet. The modem 758, which can be internal or external and a wire and/or wireless device, connects to the system bus 708 via the input device interface 742. In a networked environment, program modules depicted relative to the computer 702, or portions thereof, can be stored in the remote memory/storage device 750. It will be appreciated that the network connections shown are exemplary and other means of establishing a communications link between the computers can be used.

The computer 702 is operable to communicate with wire and wireless devices or entities using the IEEE 802 family of standards, such as wireless devices operatively disposed in wireless communication (e.g., IEEE 802.7 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.7x (a, b, g, etc.) to provide secure, reliable, fast wireless connectivity. A Wi-Fi network can be used to connect computers to each other, to the Internet, and to wire networks (which use IEEE 802.3-related media and functions).

FIG. 8 illustrates a block diagram of an exemplary communications architecture 800 suitable for implementing various embodiments as previously described. The communications architecture 800 includes various common communications elements, such as a transmitter, receiver, transceiver, radio, network interface, baseband processor, antenna, amplifiers, filters, and so forth. The embodiments, however, are not limited to implementation by the communications architecture 800.

As shown in FIG. 8, the communications architecture 800 comprises includes one or more clients 802 and servers 804. The clients 802 may implement the client system 310. The servers 804 may implement the server systems 330, 400. The clients 802 and the servers 804 are operatively connected to one or more respective client data stores 808 and server data stores 810 that can be employed to store information local to the respective clients 802 and servers 804, such as cookies and/or associated contextual information.

The clients 802 and the servers 804 may communicate information between each other using a communication framework 806. The communications framework 806 may implement any well-known communications techniques, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The clients 802 and the servers 804 may include various types of standard communication elements designed to be interoperable with the communications framework 806, such as one or more communications interfaces, network interfaces, network interface cards (NIC), radios, wireless transmitters/receivers (transceivers), wired and/or wireless communication media, physical connectors, and so forth. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media. One possible communication between a client 802 and a server 804 can be in the form of a data packet adapted to be transmitted between two or more computer processes. The data packet may include a cookie and/or associated contextual information, for example.

Various embodiments may be implemented using hardware elements, software elements, or a combination of both. Examples of hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may comprise an article of manufacture. An article of manufacture may comprise a storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method, comprising:
receiving diagnostic messages for a diagnostic activity spanning multiple threads within a process, multiple processes or multiple devices;
retrieving an activity identifier for the diagnostic activity;
retrieving metadata associated with the activity identifier; and
storing the diagnostic messages as annotated diagnostic messages with the activity identifier and associated metadata in a diagnostic log data file.

2. The method of claim 1, comprising defining the metadata as a set of key-value pairs, where the key represents a name or identifier for the metadata to be stored in the diagnostic log data file, and the value represents a metadata value.

3. The method of claim 1, comprising filtering a set of annotated diagnostic messages stored in the diagnostic log data file based on the associated metadata to form a set of filtered diagnostic messages.

4. The method of claim 1, comprising receiving diagnostic messages for the diagnostic activity, with some of the diagnostic messages representing a diagnostic sub-activity nested within the diagnostic activity.

5. The method of claim 1, comprising generating a hierarchical structure for the annotated diagnostic messages based on different activity identifiers for the annotated diagnostic messages stored in the diagnostic log data file.

6. The method of claim 1, comprising controlling a level of description for the diagnostic messages based on the associated metadata.

7. A computer program product, comprising a computer readable usable medium having computer readable program code embodied therein, the computer readable program code adapted to be executed to implement a method comprising:
receiving diagnostic messages for a diagnostic activity spanning multiple threads within a process, multiple processes or multiple devices;
annotating the diagnostic messages with context information to form annotated diagnostic messages; and
storing the annotated diagnostic messages in a diagnostic log data file.

8. The computer program product of claim 7, further comprising computer program code adapted to be executed to implement a method comprising annotating the diagnostic messages with context information, the context information comprising an activity identifier for the diagnostic activity, and metadata associated with the activity identifier.

9. The computer program product of claim 7, further comprising computer program code adapted to be executed to implement a method comprising annotating the diagnostic messages with context information, the context information comprising metadata associated with the activity identifier, the metadata comprising a set of key-value pairs, where the key represents a name or identifier for the metadata to be stored in the diagnostic log data file, and the value represents a metadata value.

10. The computer program product of claim 7, further comprising computer program code adapted to be executed to implement a method comprising receiving diagnostic messages for the diagnostic activity, the diagnostic messages representing a diagnostic sub-activity nested within the diagnostic activity.

11. The computer program product of claim 7, further comprising computer program code adapted to be executed to implement a method comprising generating a hierarchical structure for the diagnostic messages based on the context information.

12. The computer program product of claim 7, further comprising computer program code adapted to be executed to implement a method comprising controlling a level of description for the diagnostic messages based on the context information.

13. The computer program product of claim 7, further comprising computer program code adapted to be executed to implement a method comprising filtering a set of diagnostic messages stored in the diagnostic log data file based on the context information to form a set of filtered diagnostic messages.

14. An apparatus, comprising:
a memory to store a diagnostic manager component; and
a processor coupled to the memory, the processor operative to execute instructions for the diagnostic manager component, the diagnostic manager component operative to receive diagnostic messages for a diagnostic activity spanning multiple threads within a process, multiple processes or multiple devices, annotate the diagnostic messages with context information to form annotated diagnostic messages, and store the annotated diagnostic messages in a diagnostic log data file.

15. The apparatus of claim 14, the diagnostic manager component operative to annotate the diagnostic messages with context information, the context information comprising an activity identifier for the diagnostic activity, and metadata associated with the activity identifier.

16. The apparatus of claim 14, the diagnostic manager component operative to annotate the diagnostic messages with context information, the context information comprising metadata associated with the activity identifier, the metadata comprising a set of key-value pairs, where the key represents a name or identifier for the metadata to be stored in the diagnostic log data file, and the value represents a metadata value.

17. The apparatus of claim 14, the diagnostic manager component operative to receive diagnostic messages for the diagnostic activity, the diagnostic messages representing a diagnostic sub-activity nested within the diagnostic activity.

18. The apparatus of claim 14, the memory to store a diagnostic reporting component, the processor operative to execute instructions for the diagnostic reporting component, the diagnostic reporting component operative to generate a report view of diagnostic messages stored in the diagnostic log data file based on the context information.

19. The apparatus of claim 14, the memory to store a filter component, the processor operative to execute instructions for the filter component, the filter component operative to filter a set of diagnostic messages stored in the diagnostic log data file based on the context information to form a set of filtered diagnostic messages.

20. The apparatus of claim 14, the memory to store a hierarchy generator component, the processor operative to execute instructions for the hierarchy generator component, the hierarchy generator component operative to generate a hierarchical structure for the diagnostic messages based on the context information.
